(19) United States
(12) Patent Application Publication
(10) Pub. No.: US 2017/0120554 A1
(43) Pub. Date: May 4, 2017

(54) Product or Sheet, Combined with a Mesh or Meshes

(71) Applicant: TamiCare Ltd., Heywood (GB)

(72) Inventors: Tamar Giloh, Heywood (GB); Ehud Giloh, Heywood (GB)

(21) Appl. No.: 15/333,443

(22) Filed: Oct. 25, 2016

Related U.S. Application Data
(60) Provisional application No. 62/247,428, filed on Oct. 28, 2015.

(51) Int. Cl. B32B 5/02; B32B 27/12

(52) U.S. Cl. CPC B32B 5/028; B32B 27/12; B32B 2307/50

(57) ABSTRACT

A composite sheet is provided, where the composite sheet has a bottom surface and an upper surface and includes: (a) at least one layer of interconnected polymer droplets, and (b) at least one mesh having a bottom surface and an upper surface, wherein the at least one mesh is embedded into at least a part of the at least one layer of interconnected polymer droplets such that the polymer droplets surround and hold at least a part of said bottom and upper surfaces of the at least one mesh.

### RELATED APPLICATIONS

This application claims priority U.S. Provisional Application No. 62/247,428 entitled “Product or sheet, combined with a mesh or meshes,” filed on Oct. 28, 2015, which is hereby incorporated by reference in its entirety.

### BACKGROUND OF THE INVENTION

The textile industry, including woven, knitted and non-woven technologies use meshes for fabric strengthening, product decoration, product ventilation and more. Currently, adding meshes involves gluing and sawing of the mesh layer with premade finished textile sheets. The additive manufacturing technology as described in the following prior art U.S. patent applications and patents, which are incorporated by reference in their entirety, utilize meshes to create surprisingly improved solutions: U.S. Provisional Application No. 62/246,689, filed Oct. 27, 2015; U.S. patent application Ser. No. 13/531,024, filed Jun. 22, 2012; U.S. patent application Ser. No. 13/328,024, filed Dec. 16, 2011; U.S. patent application Ser. No. 13/546,538, filed Jul. 11, 2012; U.S. Pat. No. 7,901,740; U.S. Pat. No. 8,323,764; and U.S. Pat. No. 8,323,764.

### SUMMARY OF THE INVENTION

This application discloses a product or sheet, the product or sheet created by an additive manufacturing process, comprising at least one layer of interconnected polymer droplets, wherein a mesh material is embedded into at least a part of the at least one layer of interconnected polymer droplets, to create an integrated composite material.

The composite material is characterized by the fact that the polymer droplets are hooked within and/or around at least a part of said mesh.

The product may comprise further layers of interconnected polymer droplets, and meshes, built in different compositions, to create a composite material with multiple layers.

The composite material may include an upper surface and a bottom surface. In addition, loose fiber may be added, as an outer layer, onto at least a part of a polymeric layer surface.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 illustrates an example mesh structure, according to an example embodiment.

FIG. 2 illustrates another example mesh structure, according to an example embodiment.

FIG. 3 illustrates a cross-sectional view of a hybrid composite fabric made with two different interconnected polymeric droplets and a screen embedded between the two layers, according to an example embodiment.

### DETAILED DESCRIPTION OF THE INVENTION

Exemplary apparatus and methods are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed apparatus and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

As used herein, “mesh” means a material with a plurality of holes. The mesh may include metal, any elastic or plastic material, carbon fibers, non-woven material, textile, or any other material as desired. The mesh may be rigid or flexible, and may include one or more sections of varying rigidity/stretch characteristics. Although used in the singular, “mesh” may also encapsulate a plurality of meshes.

As used herein, “interconnected polymer droplets” means droplets of polymers applied by spraying in such a way that the droplets are touching each other so they are partly or completely merged. A sheet made by said interconnected polymer droplets may comprise both completely merged droplets and partially connected droplets. One example for suitable polymers may include a family of polyurethane dispersions (PUD). One example of such a polymer is Impranil DHL produced by Covestro.

A composite sheet of fabric or a product made of such composite is described herein. The composite sheet of fabric or a product made of such composite comprises at least one layer of interconnected polymer droplets having a bottom surface and an upper surface, wherein a mesh having holes and having a bottom surface and upper surface is embedded into at least a part of the at least one layer of interconnected polymer droplets, to create an integrated composite material.

The composite sheet is characterized by the fact that the polymer droplets surround and hold at least a part of said mesh and there is a continuity of the polymer droplets layer through the mesh holes. Examples for mesh materials include, metal, any elastic or plastic material, carbon fibers, non-woven material, textile, or any other material as desired.

In one embodiment, a single layer of interconnected polymer droplets and a single mesh is used to form the composite sheet. In another embodiment, two layers of interconnected polymer droplets and a single mesh is used to form the composite sheet. In another embodiment, a single layer of interconnected polymer droplets and two meshes are used to form the composite sheet. In yet another embodiment, two layers of interconnected polymer droplets and two meshes are used to form the composite sheet. Other examples are possible as well.

In such examples, the two layers of interconnected polymer droplets may be the same, or they may be different. For example, a first layer of interconnected polymer droplets may have a first thickness that is greater than a second thickness of the second layer of interconnected polymer droplets. In another example, the first layer of interconnected polymer droplets may comprise a first material that is different than a second material that makes up the second layer of interconnected polymer droplets. Similarly, in the embodiments described above with two meshes, the two meshes may be the same, or they may be different. For example, a first mesh may have a first thickness that is greater than a second thickness of a second mesh. In another example, the first mesh may comprise a first material that is different than a second material that makes up the second mesh. Other differences are possible as well.

The resultant material can be a hybrid, reinforced, and/or shape-holding fabric, optionally combining the resiliency and/or the mechanical strength and/or rigidity of the mesh(es), together with the softness, comfort and pleasant feel of a textile or cloth like fabric. The hybrid/composite mesh-fabric sheet or product may be used for forming any garment, shoe, helmet, curtain, carpet, packaging item, furniture, upholstery, a component of any of the above mentioned product, or for any other product, product component or application.

In one embodiment, the mesh is fully trapped between polymer droplets attached to its bottom and upper surfaces.

In another embodiment, the mesh is partly trapped between polymer droplets attached to its bottom and upper surfaces, so that the mesh is uncovered either within the polymeric layer boundaries, or beyond the polymeric layer boundaries. In a specific product or sheet, numerous uncovered mesh areas within and beyond the polymeric layer boundaries are possible. Such embodiments may serve for decoration, ventilation, hooking and other functional or design purposes.

In yet another embodiment the mesh is fully or partly trapped between polymeric droplets of more than one polymeric material.

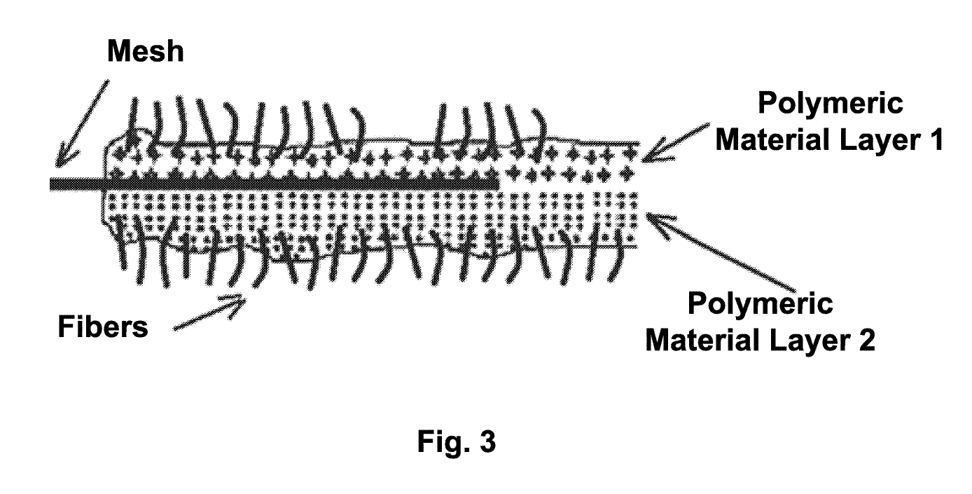

In yet another embodiment, loose fibers may be added onto at least a part of a polymeric layer body or surface, preferably by a flocking process. Such an embodiment is shown in FIG. 3.

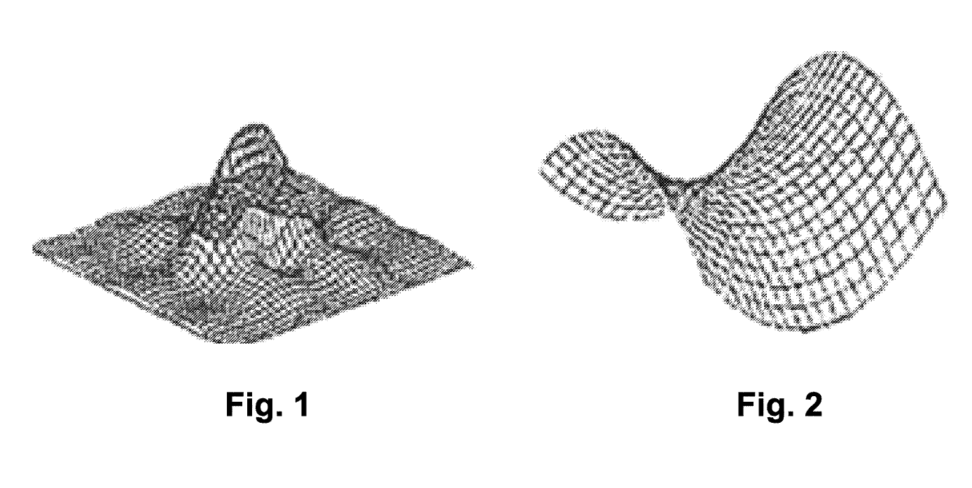

The mesh may be rigid or stretchable, shape-holding or loose, flat or curved (see FIG. 2) and having a complex structure (see FIG. 1). In one embodiment, the mesh is bendable. The mesh may be the base for, or may largely contribute to, keeping the shape of the finished product. The mesh may be added to any desired zone of the product. Alternatively, the mesh may also protrude out the finished product or the sheet boundaries. In one embodiment, such a protruding section of a mesh is used as a connecting section, facilitating linking with adjacent component or to another product.

The sheet or product may be created by spraying a liquid polymer over a surface such as conveyor belt or a mold to create the interconnected polymer droplets layer and further placing a mesh at the desired location. Said liquid polymer may be provided as solutions, dispersions or suspensions. Such liquid polymer may be a waterborne polymer liquid. The step of placing the mesh over the polymeric layer may be carried out while the interconnected polymer droplets are still wet or at least partially wet. If required, the process of spraying the polymer continues to thereby form interconnected droplets on top of at least a part of the already existing droplets layer and/or the at least a part of the added mesh, to produce the composite sheet.

In one embodiment, the process comprises applying loose fibers to at least a part of the upper surface of the sheet or product, while the polymer droplets are at least partially wet, to provide a smooth hand feel and or a special product design and functionality.

In another embodiment, the process comprises applying loose fibers to at least a part of the bottom surface of the sheet or product, before the polymer droplets are sprayed, to provide a smooth hand feel and or to provide a special product design and functionality.

In one example, the mesh can be precisely placed by a robotic arm utilizing a pick and place technology.

The process also comprises curing step or steps, according to the composite characteristics, such as polymers type, meshes type, multiple polymer types, additives incorporated in the sheet, etc.

One example of apparatus to carry the process is a manufacturing system comprising a conveyor, comprising moving plates, one or more spraying units, one or more flocking units, one or more robotic arms, and one or more curing ovens.

While various aspects and embodiments have been disclosed herein, other aspects and embodiments will be apparent to those skilled in the art. All embodiments within and between different aspects of the invention can be combined unless the context clearly dictates otherwise.

The various aspects and embodiments disclosed herein are for purposes of illustration and are not intended to be limiting, with the true scope and spirit being indicated by the following claims.

1. A composite sheet having a bottom surface and an upper surface, wherein the composite sheet comprises:
at least one layer of interconnected polymer droplets; and
at least one mesh having a bottom surface and an upper surface, wherein the at least one mesh is embedded into at least a part of the at least one layer of interconnected polymer droplets such that the polymer droplets surround and hold at least a part of said bottom and upper surfaces of the at least one mesh.

2. The composite sheet according to claim 1, further comprising at least one additional layer of interconnected polymer droplets.

3. The composite sheet according to claim 1, wherein the at least one layer of interconnected polymer droplets comprises more than one polymer type.

4. The composite sheet according to claim 1, further comprising at least one additional mesh.

5. The composite sheet according to claim 1, wherein the at least one mesh protrudes out of the interconnected polymer droplets layer boundaries.

6. The composite sheet according to claim 1, wherein within the external boundaries of the interconnected polymer droplets layer the at least one mesh is partly uncovered.

7. The composite sheet according to claim 1 further comprising loose fibers positioned onto at least part of the at least one layer of interconnected polymer droplets

8. The composite sheet according to claim 1, wherein the at least one mesh comprises one or more sections of different rigidity/stretch.

9. The composite sheet according to claim 1, wherein a shape of the composite sheet can be manipulated due to the mesh rigidity/stretch characteristics.

10. The composite sheet according to claim 1, wherein a partly embedded mesh is used as a connecting section, facilitating linking with adjacent component or with another product.
